(19) United States
(12) Patent Application Publication
(10) Pub. No.: US 2023/0339611 A1
(43) Pub. Date: Oct. 26, 2023

(54) Multiple Cargo Carrying Delivery System for an Unmanned System and Method of Use

(71) Applicant: Unmanned Systems Operations Group, Inc., Temecula, CA (US)

(72) Inventors: Pharns Genece, Temecula, CA (US); Jeff Simons, Vista, CA (US); Mark Kosko, Anaheim, CA (US)

(73) Assignee: Unmanned Systems Operations Group, Inc., Temecula, CA (US)

(21) Appl. No.: 17/796,815

(22) PCT Filed: Jan. 31, 2021
(86) PCT No.: PCT/US2021/015966

§ 371 Date: Aug. 1, 2022

Related U.S. Application Data
(60) Provisional application No. 62/968,517, filed on Jan. 31, 2020.
(60) Provisional application No. 63/076,886, filed on Sep. 10, 2020.
(60) Provisional application No. 63/077,668, filed on Sep. 13, 2020.
(60) Provisional application No. 63/198,023, filed on Sep. 24, 2020.

(51) Int. Cl. B64D 9/00; B60P 7/10; B60P 7/135; B31B 50/86; B65D 25/28

(52) U.S. Cl. CPC B64D 9/003; B60P 7/10; B60P 7/135; B31B 50/87; B65D 25/2826; B64U 10/00

(57) ABSTRACT

A bail hook for use with cargo is disclosed. The bail hook can have a base plate, a spacer and a handle. The bail hook can also include a handle plate located between the base plate and the handle. The bail hook can include position markers located along an edge of the base plate and the handle plate. The bail hook can include a handle mount located between the handle plate and the handle. The bail hook can have a first and second flap slot configured to receive a first and second box flap. The bail hook can have a bevel, where the bevel can be located on the handle plate. The bail hook can be made from plastic or a combination of materials, such as metal. A method of use of the bail hook with box cargo is also disclosed.

### BACKGROUND OF THE INVENTION

There is a growing demand for payload or cargo transport by unmanned vehicles. Conventional unmanned vehicles transport one cargo item to a single destination and then return to the point of origin before commencing the next delivery. A more efficient, cost-effective, and safe means of transporting multiple cargo on a single mission is required.

A multi-cargo delivery system and method is needed to attach cargo of varying size, shape, and weight to an unmanned vehicle, and mechanically and electrically interface with the unmanned vehicle computer, power, and accompanying systems. The multi-cargo delivery system should be automated, not requiring personnel to connect or disconnect wiring connectors for data, control signals, or power when changing payloads, and capable of delivering cargo to multiple destinations prior to return to a cargo loading area. The multi-cargo delivery system should likewise be able to remotely and securely latch cargo without the aid of personnel.

### SUMMARY OF THE INVENTION

The present invention is directed toward a bail hook. In some embodiments, the bail hook is used with an unmanned system. In various embodiments, the bail hook includes a base plate, a spacer and a handle. In further embodiments, the spacer is mounted to the base plate. In additional embodiments, the handle is mounted to the spacer.

In some embodiments, the bail hook can have a handle plate. In further embodiments, the handle plate is located between the spacer and the handle.

In certain embodiments, the bail hook further comprises at least one position marker. In further embodiments, the at least one position marker is located along an edge of the base plate. In additional embodiments, the at least one position marker is located substantially at a center point of the edge of the base plate. In other embodiments, the bail further comprises a handle plate, wherein at least one position marker is located along an edge of the handle plate. In further embodiments, the at least one position marker is located substantially at the center of an edge of the handle plate.

In additional embodiments, the bail hook further comprises a handle mount. In further embodiments, the handle mount is located between the spacer and the handle.

In certain embodiments, the bail further comprises a first flap slot and a second flap slot. In further embodiments, the first flap slot is configured to receive a first box flap and the second box flap is configured to receive a second box flap.

In various embodiments, the bail hook further comprises a bevel.

In some embodiments, the bail hook is made from plastic.

In additional embodiments, the bail hook if manufactured using injection molding.

In certain embodiments, the handle is made from a material different from the base plate and the spacer.

In various embodiments, the handle is made from metal.

The present invention is also directed toward a method of using a bail hook with a piece of cargo where the bail hook has a base plate, a spacer, a handle, a first flap slot and a second flap slot. In some embodiments, the method includes the steps of inserting a first box flap into the first flap slot, folding the first box flap and bail hook to a closed position, folding the second box flap to a closed position, inserting the second box flap into the second flap slot, then securing the first box flap and the second box flap in the closed position thereby securing the bail hook to the piece of cargo.

In some embodiments, the first box flap and the second box flap are secured in the closed position using at least one from the group consisting of tape, straps, adhesive, and wire.

In additional embodiments, the method includes the step of positioning the bail hook substantially in the center of an edge of the first box flap and an edge of the second box flap.

The present invention is also directed toward an additional method of using the bail hook having a base plate, a spacer, a handle, a first flap slot and a second flap slot. In some embodiments, the method includes the steps of folding a first cargo box flap of a piece of cargo to a closed position, folding a second box flap of a piece of cargo to a closed position thereby forming a gap between the first box flap and the second box flap, positioning the bail hook at an edge of the piece of cargo such that the spacer is aligned lengthwise with the gap, inserting the bail hook into the gap such that the first cargo box flap is inserted into the first flap slot and the second cargo box flap is inserted into the second flap slot, and securing the first cargo box flap and the second cargo box flap in the closed position.

In some embodiments, the method includes the step of moving the bail hook to a position substantially in the center of the first box flap and second box flap.

In other embodiments, the first box flap and the second box flap are secured in the closed position using at least one from the group consisting of tape, straps, adhesive, and wire.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a bottom view of a pallet adapter;

FIG. 2A is a top view of a pallet;

FIG. 2B is a perspective view of a pallet adapter aligned with a pallet prior to connection;

FIG. 2C is a side view of a pallet adapter aligned with a pallet prior to connection;

FIG. 2D is an end view of a pallet adapter connected to a pallet;

FIG. 3A is a front view of a pallet adapter aligned with a pallet, the pallet having cargo modules connected thereto;

FIG. 3B is a perspective view of a pallet adapter aligned with a pallet, the pallet having cargo modules connected thereto;

FIG. 3C is a bottom view of a pallet adapter aligned with a pallet, the pallet having cargo modules connected thereto;

FIG. 4A is a side view of an attachment fixture configured to attach to cargo;

FIG. 4B is a top view of an attachment fixture configured to attach to cargo;

FIG. 4C is a front view of an attachment fixture attached to box cargo;

FIG. 5 is a front view of a pallet adapter connected to a pallet, the pallet having multiple cargo modules connected thereto and box cargo with attachment fixtures aligned with the cargo modules;

FIG. 6A is a perspective view of a pallet adapter connected to a pallet, the pallet having multiple cargo modules connected thereto, the cargo modules configured to receive box cargo and envelope cargo;

FIG. 6B is a side view of a pallet adapter connected to a pallet, the pallet having multiple cargo modules connected thereto, the cargo modules having box cargo and envelope cargo secured to the cargo modules;

FIG. 7A is a diagram of multiple hold and release mechanisms of a cargo module showing the hold and release mechanisms electrically connected to a processor configured to control the hold and release mechanisms;

FIG. 7B is a diagram of multiple hold and release mechanisms under the control of a processor;

FIG. 8 is a block diagram showing various types of modules configured to attach to a pallet and under the control of a processor and communicating with a supervisory system;

FIG. 9A is a perspective view of an embodiment of a bail hook;

FIG. 9B is a side view of an embodiment of a bail hook;

FIG. 9C is a perspective view of an embodiment of the bail hook partially engaged with a piece of cargo;

FIG. 9D is a perspective view of an embodiment of the bail hook fully engaged with a piece of cargo;

FIG. 9E is a cutaway view of an embodiment of the bail hook fully engaged with a piece of cargo;

FIG. 10A is a perspective view of an embodiment of a hold and release mechanism mounted to a portion of a pallet;

FIG. 10B is a bottom view of an embodiment of the hold and release mechanism mounted to a portion of a pallet;

FIG. 11A is a perspective view of an embodiment of the bail hook fully engaged with an embodiment of the hold and release mechanism;

FIG. 11B is a side view of an embodiment of the bail hook fully engaged with an embodiment of the hold and release mechanism;

FIG. 11C is a front view of an embodiment of the bail hook fully engaged with an embodiment of the hold and release mechanism;

FIG. 12 is a flow chart showing a method of use of the present invention; and

FIG. 13 is a flow chart showing a method of use of the present invention;

FIG. 14 is a flow chart showing a method of use of the present invention.

### DETAILED DESCRIPTION

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar reference indicators will be used throughout the drawings and the following detailed description to refer to the same or like parts.

In the interest of clarity, not all of the routine features of the implementations described herein are shown and described. It will, of course, be appreciated that in the development of any such actual implementations, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

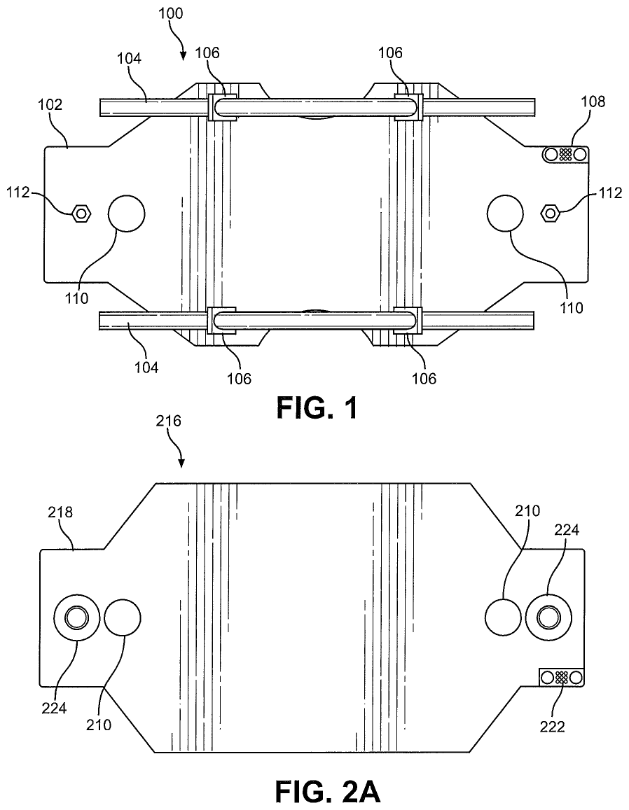

Referring initially to FIG. 1, is one embodiment of a pallet adapter 100 of the present invention is shown. The pallet adapter 100 comprises a pallet adapter plate 102 that may be made of metal, plastic, alloy or any suitable material that can withstand determined cargo loads, weather, and environmental conditions. The pallet adapter plate 102 can be configured in various shapes and sizes to fit to an unmanned vehicle as an attachment or embedded into the design of an unmanned vehicle itself.

FIG. 1 illustrates one embodiment of the pallet adapter 100 comprising a pallet adapter plate 102, a rail connector 106 configured to attach to an attachment rail of an unmanned vehicle. The pallet adapter 100 further comprises an electrical socket 108, a retaining pin 112 and a pass through 110. The shape and size of the pallet adapter plate 102 can be determined in part by the location of any landing gear or struts associated with the unmanned system. The pallet adapter plate 102 attaches to an unmanned vehicle to facilitate cargo transport and other payloads.

Rail connectors 106 are fixed to the bottom of the pallet adapter plate 102. Rail connectors 106 include any type of fastener, such as a bracket or clamp, that can connect module attachment rails 104 to the pallet adapter plate 102. The rail connectors 106 are welded, or secured by other suitable means such as nuts and bolts, to the pallet adapter plate 102.

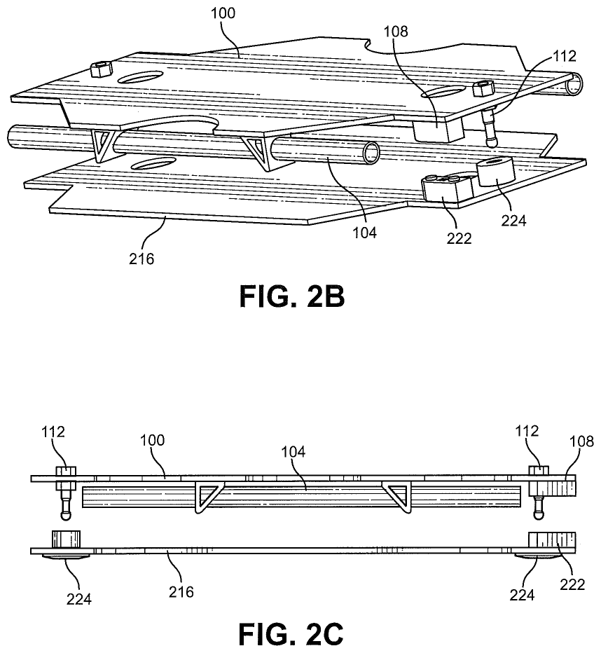

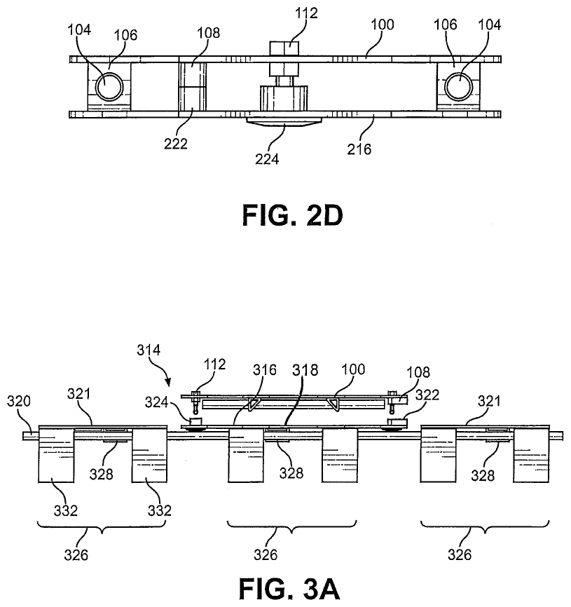

The module attachment rails 104 are used to support the pallet adapter 100, a pallet 216 (see FIG. 2a) and payloads including cargo. The rail connectors 106 and module attachment rails 104 can be made of carbon fiber, metal, alloy, plastic, or any other suitable material that can withstand determined payloads as well as weather and environmental conditions. The rail connectors 106 and module attachment rails 104 may be configured at various positions on the pallet adapter plate 102. In one embodiment, the rail connectors 106 and module attachment rails 104 are positioned along each length of the pallet adapter plate 102.

A retaining pin 112 is secured to the pallet adapter plate 102 and extends from the pallet adapter plate 102. The pallet adapter plate 102 may have multiple retaining pins 112 positioned at various locations on the pallet adapter plate 102. The retaining pin 112 can be any pin or other device that mates with a corresponding socket or device, for example the retaining socket 224 illustrated in FIG. 2a, and is capable of supporting the weight of the pallet adapter 100, pallet 216, and any attached payload(s). The present invention can use other types of connections such as hooks, straps, and magnets to secure the pallet adapter 100 to the pallet 216.

An electrical socket 108 is secured to the pallet adapter plate 102. The electrical socket 108 can be positioned in various locations on the pallet adapter plate 102. In one embodiment, the electrical socket 108 is secured to a corner of the pallet adapter plate 102. The electrical socket 108 and corresponding electrical plug 222 shown in FIG. 2a are constructed from materials that are able to withstand vibrations and shock loads induced by the unmanned vehicle during all phases of operation. The electrical socket 108 is configured to pass communication signals and power to the pallet 216 and any modules connected thereto.

In one embodiment, the pallet adapter plate 102 comprises pass through 110. The pass through 110 are cut outs in the pallet adapter plate 102 that allow electrical wiring, conduits, and other components, such as hydraulic and air lines, to pass through the pallet adapter plate 102. The pass through 110 cut outs may vary in shape (for example, circular or square), size, and location on the pallet adapter plate 102 to accommodate the components secured to the pallet 216.

Referring to FIGS. 2a, 2b, 2c and 2d, is one embodiment of a pallet 216 of the present invention that is configured to attach to the pallet adapter 100. The pallet 216 comprises a pallet plate 218 made of metal, plastic, alloy or any suitable material that can withstand determined cargo loads, weather, and environmental conditions. In a typical embodiment, the pallet plate 218 has a shape similar to the pallet adapter 100, however, the pallet plate 218 may have any shape, such as a circle or square.

The top side of the pallet plate 218 comprises an electrical plug 222 positioned to align and mate with the electrical socket 108 attached to the pallet adapter plate 102, a retaining socket 224 positioned to align and mate with the retaining pin 112 attached to the pallet adapter plate 102, and a pass through 210 positioned to align with the pass through 110 as illustrated in FIGS. 2b, 2c, and 2d.

The electrical plug 222 and electrical socket 108 self-align and mate to facilitate communication and power between the present invention and an unmanned vehicle. The present invention can utilize wireless power and communication between the unmanned system and the present invention in conjunction with the electrical plug 222 and the electrical socket 108. The present invention can utilize a wireless power and communication system instead of the electrical plug 222 and the electrical socket 108. The present invention can use any type of power and communication transfer between the unmanned vehicle and the present invention that satisfies the spirt and scope of the present invention such as, but not limited to, near field communication.

The retaining pin 112 aligns and mates with the retaining socket 224 by applying pressure until the retaining pin 112 and retaining socket 224 fully engage. Disconnecting the retaining pin 112 from the retaining socket 224 is accomplished by depressing the retaining socket. In some embodiments, the retaining socket 224 is actuated to release the retaining pin 112 by an electrical signal, hydraulic pressure, or air pressure.

The rail connectors 106 sit flush with the lengths of the pallet plate 218 as illustrated in FIG. 2d, however, the rail connectors 106 may be located at any distance from the pallet plate 218 while still accomplishing the goals of the present invention.

In some embodiments, a cable (not shown), such as a safety lanyard, is attached to the pallet adapter 100 and the pallet 216. If the pallet 216 was to unintentionally disengage from the pallet adapter 100, the cable ensures the pallet 216 and any cargo attached thereto will not fall away, which may present a hazard to people or objects on the ground.

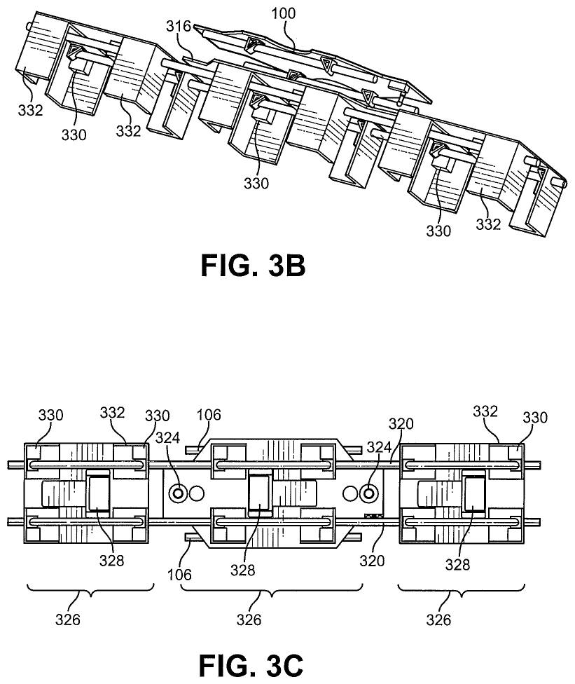

Referring to FIGS. 3a, 3b, and 3c, is one embodiment of a multiple cargo module 314 of the present invention comprising a pallet adapter 100 and a pallet 316. The pallet 316 comprises a pallet plate 318. The pallet plate 318 may be configured in different sizes, shapes, material and interface to accommodate any unmanned vehicle system.

FIGS. 3a, 3b, and 3c illustrate one embodiment of the pallet 314 comprising 3 separate box cargo modules 326 supported by module attachment rails 320. The number of cargo modules 326 is limited in part by the unmanned vehicle's weight carrying constraints and maintaining balance during transport. As one non-limiting example, there may be multiple cargo modules attached to the module attachment rail 320 forming a “T”, “X”, “H”, or “+” (plus) configuration.

The module attachment rail 320 attaches to the pallet plate 318 and one or more cargo modules 326 to facilitate the transport of multiple cargo loads to the same or different locations. The module attachment rail 320 is attached or otherwise secured to the pallet plate 318. In one embodiment, the module attachment rails 320 pass through the sides of the cargo guides 332. Each cargo module 326 is then attached to or otherwise secured to the module attachment rail 320. The module attachment rail 320 may be any length necessary to attach a desired number of cargo modules 326, or other types of modules such as a camera module, spotlight module, speaker module, and a sensor module, where the sensor module may contain one or more sensors, such as, but no limited to, temperature, barometric pressure, and particulate detectors.

The cargo modules 326 may vary in number, size, and configuration. The number and weight of cargo items that can be transported are limited in part by the unmanned vehicle's weight carrying constraints. In certain embodiments, each box cargo module 326 comprises cargo guides 332 fixed to the bottom edges of the pallet plate 318 and cargo pallets 321. The cargo guides 332 may be made of metal, plastic, alloy or any suitable material that can withstand the weather, environmental conditions, cargo weight, and any vibrations caused by the unmanned vehicle. The cargo guides 332 can be welded or otherwise suitably attached to the pallet 316 and cargo pallets 321. The cargo guides 332 may vary in number, shape (for example, rectangular or square), size, and attachment position. For example, there could be only one cargo guide 332 attached to the center of each length of the pallet plate 318 and cargo pallets 321.

The cargo guides 332 aid in alignment of cargo into the cargo module 326. The cargo then stops at the cargo spacer 330 and connects to a hold and release mechanism 328 fastened to the bottom of the pallet plate 318 and cargo pallets 321. The cargo spacers 330 allow for space between the cargo and the hold and release mechanism 328 thereby preventing the cargo from interfering with the operation of the hold and release mechanism 328. The cargo spacers depicted in FIG. 3b are rectangular in shape and integrated into the corner of each box cargo module 326. However, the cargo spacers 330 may vary in size, shape, positioning, and can be detached from the box cargo modules 326. The cargo spacers 330 may be made of metal, plastic, alloy or any suitable material that can withstand the weather, environmental conditions, vibrations caused by the unmanned vehicle. The cargo spacers 330 may be made of metal, plastic, alloy or any suitable material that can withstand the weather, environmental conditions, and vibrations caused by the unmanned vehicle and will not compress when contact is made with the cargo containers.

The hold and release mechanism 328 retains the cargo in place until released by the unmanned vehicle or operator. The hold and release mechanism 328 may be an electro mechanical mechanism including, but not limited to, solenoids, servo actuators, magnetic release, motor driven winch mechanisms, or a combination thereof and can include a cam configured to open and close the hold and release mechanism 328.

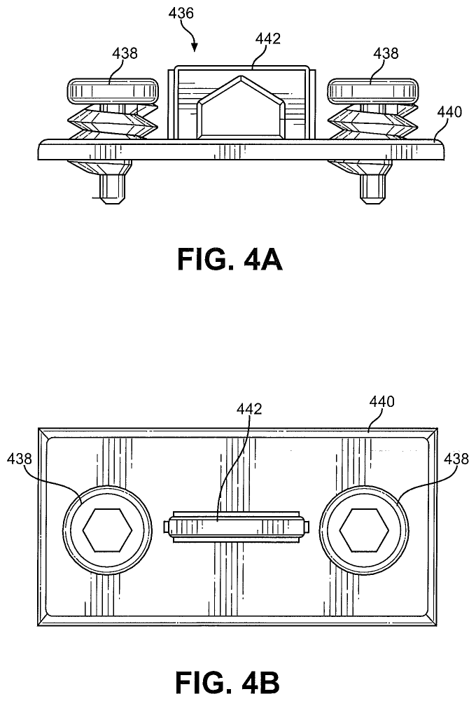

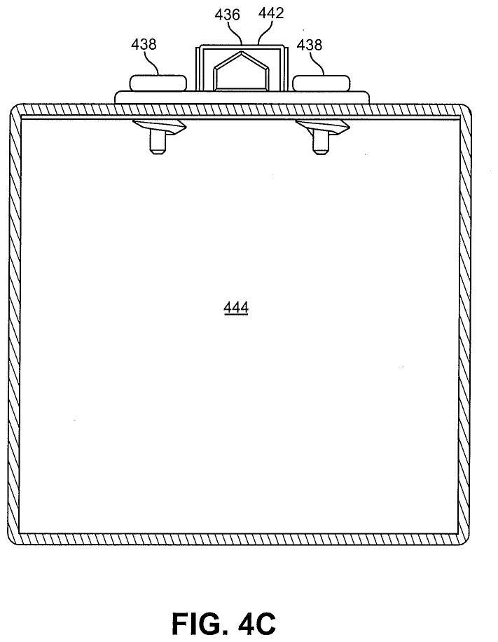

Referring to FIGS. 4a, 4b, and 4c, is one embodiment of an attachment fixture 436 of the present invention. The attachment fixture 436 comprises a retention loop 442 and connectors 438 connected to an attachment fixture base 440. The attachment fixture 436 can be tailored in size, shape, and number of connectors 438 to accommodate the cargo container weight, shape, and anticipated overall stress. For example, an attachment fixture 436 may have four (4) connectors 438 to increase the load carrying capacity of the attachment fixture 436.

The attachment fixture base 440 and retention loop 442 may be made of metal, plastic, alloy or any suitable material that can withstand the weather, environmental conditions, cargo weight, and vibrations during transport. The attachment fixture base 440 comprises a top and bottom side.

The retention loop 442 is positioned on the top of the attachment fixture base 440 and may be welded, or otherwise fastened to the attachment fixture base 440 by suitable means. The retention loop 442 interfaces with the hold and release mechanism 328. The retention loop 442 is located substantially in the middle of the attachment fixture base 440.

The connectors 438 extend through the attachment fixture base 440 and fastens to cargo, for example as illustrated in FIG. 4c. The connectors 438 may be screws or other fasteners. One non-limiting example is a screw manufactured by Makedo Company (SCRUs) that can connect to corrugated cargo containers. The connectors 438 can be connected manually to the cargo container or without tools. In alternative embodiments, the connectors 438 can be hooks, pins, clamps, or any other style known in the industry that allows for the attachment fixture 436 to be securely fasted to cargo.

Referring to FIG. 4C, the attachment fixture 436 is shown attached to a piece of box cargo 444. As shown, connectors 438 have been secured to the top of the box cargo 444 thereby allowing the box cargo 444 and attachment fixture 436 to be secured to a cargo module 326 (see FIG. 3C) by inserting the retention loop 442 into a hold and release mechanism 328 (see FIG. 3C)

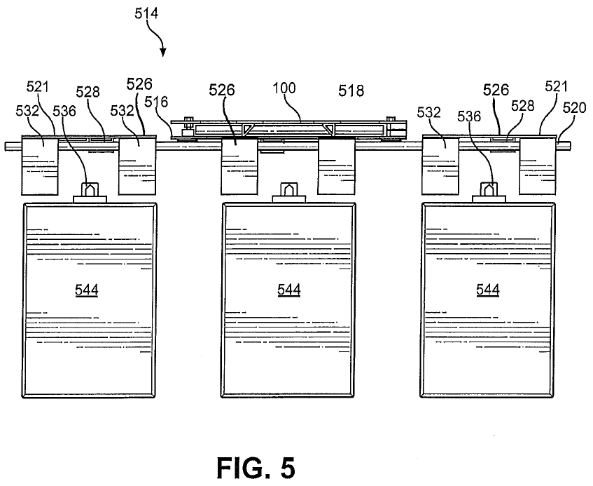

Referring to FIG. 5, is an exploded view of one embodiment of a multi cargo module 514 having three (3) cargo modules 526 and three (3) pieces of box cargo 544, each having an attachment fixture 536 attached thereto. The multi cargo module 514 comprises a pallet adapter 100 and pallet 516. The pallet 516 comprises a pallet plate 518, two (2) module attachment rails 520, and three (3) cargo modules 526. One of the cargo modules 526 is attached to the pallet plate 518. The module attachment rails 520 are attached to that cargo module. The other cargo modules 526 attach to the module attachment rail 520.

Each box cargo 544 is configured with an attachment fixture 536 and are positioned beneath the guides 532 to align the box cargo 544 with the respective cargo modules 526. In operation, the cargo box 544 is inserted into the cargo module 526 until the attachment fixture 536 engages the hold and release mechanism 528.

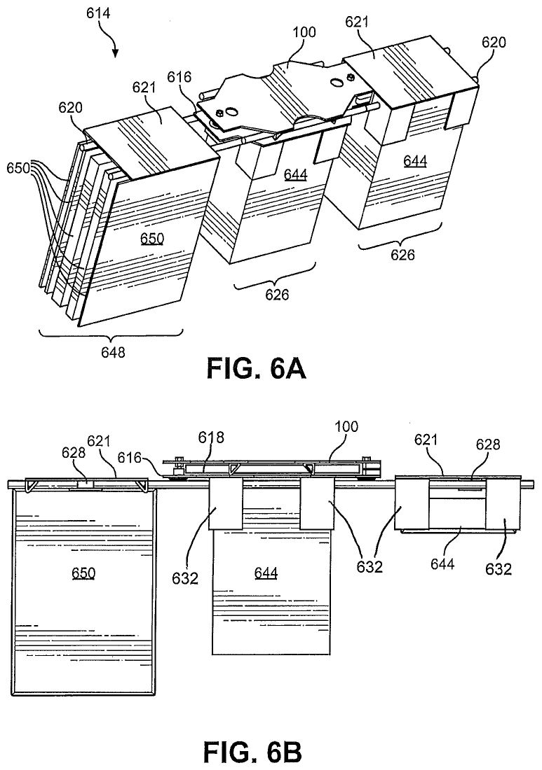

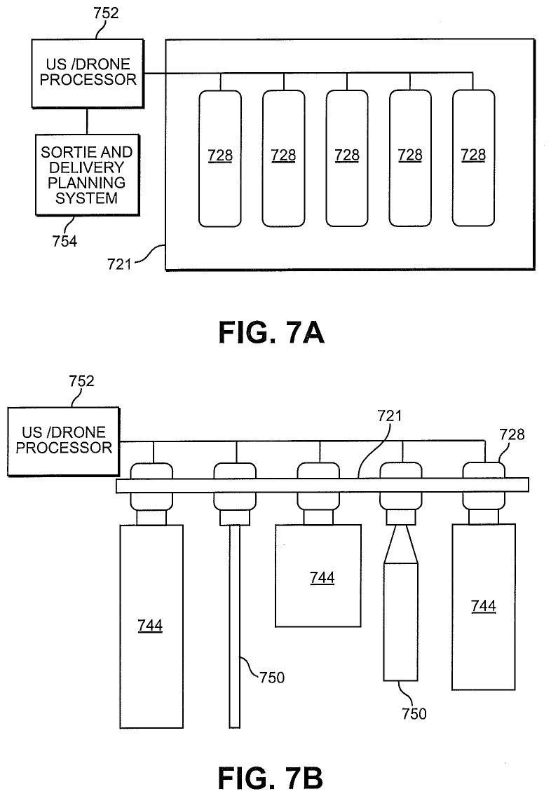

Referring to FIGS. 6a and 6b, one embodiment of a multi cargo module 614 comprising a pallet adapter 100 and a pallet 616 is shown. The pallet 616 comprises two (2) module attachment rails 620, two (2) multiple cargo modules 626, and an envelope module 648. Each box cargo module 626 comprises cargo guides 632 fixed to the bottom edges of the pallet plate 618 or cargo pallet 621. Box cargo 644 is attached and positioned within the cargo guides 632 and attached to a hold and release mechanism 528 (see FIG. 5). The envelope module 648 can have one or more hold and release mechanisms (not shown) configured to securely hold envelope cargo 650. For example, the envelope module 648 can have five (5) hold and release mechanisms (not shown, see FIGS. 7A and 7B). Unlike the box cargo modules 626, the envelope cargo 650 is attached to the envelope cargo module 648 without the assistance of cargo guides 632. Alternative embodiments may include cargo guides 632 for either the box cargo module 626 or envelope module 648. In certain embodiments, the cargo guides 632 are configured to completely enclose the top and sides of a piece of cargo to protect the cargo from external elements such as rain, sleet, and snow. The cargo guides 632 also act to obscure the cargo so the nature of the cargo cannot be determined by outside observers. In certain embodiments, the box cargo 644 and envelope cargo 650 may be enclosed by a cover or shroud to protect the contents from external elements such as rain, sleet, and snow. The cover or shroud can also help to insulate any attached cargo that is temperature sensitive, such as transplant organs, medicines, and vaccines. The shroud or cover can be made from plastic or a wax impregnated material and is configured to protect at least the top and sides of the cargo from the external elements.

In alternative embodiments, the cargo module 626 or the envelope module 648 is configured to receive a bag instead of box cargo 644 or envelope cargo 650. The bag may have a handle or a loop that is secured to the cargo module 626 or the envelope module using the hold and release mechanism 628. The hold and release mechanism 628 disengages the handle or loop to release the bag. In some embodiments, the bag can have two handles or loops, where a first handle or loop is fixedly attached to the cargo module 626 or the envelope module 650, while a second handle or loop is secured using the hold and release mechanism 628. When the hold and release mechanism 628 disengages the second handle or loop, the contents of the bag are released while keeping the bag secured to the cargo module 626 or envelope module 648.

Referring to FIGS. 7a and 7b, one embodiment of an envelope module 748 having multiple hold and release mechanisms 728 is shown. The envelope module 748 can have two or more hold and release mechanisms 728. As shown in FIGS. 7A and 7B, the envelope module 748 comprises five hold and release mechanisms 728, however this is not to be considered limiting. Each hold and release mechanism 728 is independently controlled and operated by an Unmanned System/Drone processor 752. During operation, the unmanned system/drone processor 752 activates one or more of the one or more hold and release mechanisms 728, which releases any cargo captured by the hold and release mechanism 728. The unmanned system/drone processor receives information from a sortie and delivery planning system 754. The sortie and delivery planning system 754 determines, in part, the destinations for each piece of cargo and the path an unmanned system will follow from one destination to the next then back to the base where the unmanned system first departed. The sortie and delivery planning system can also direct an unmanned system to start its delivery operation at one location and finish its delivery operation at a different location. When the unmanned system/drone processor 752 determines the unmanned system has reached a desired destination for a particular piece of cargo, the unmanned system/drone processor 752 activates the associated hold and release mechanism 728 thereby releasing the piece of cargo designated for that destination. The unmanned system/drone processor may activate more than one hold and release mechanism 728 at any given destination for each piece of cargo designated to be delivered to that destination. The sortie and delivery planning system 754 can also direct the unmanned system to pick up new cargo at any given destination.

FIG. 7B is a diagram of cargo pallet 721 configured with five (5) hold and release mechanisms 728. Each of the hold and release mechanisms 728 are controlled independently by the US/Drone Processor 752. As shown in FIG. 7B, the box cargo 744 and the envelope cargo 750 are attached to the hold and release mechanisms 728.

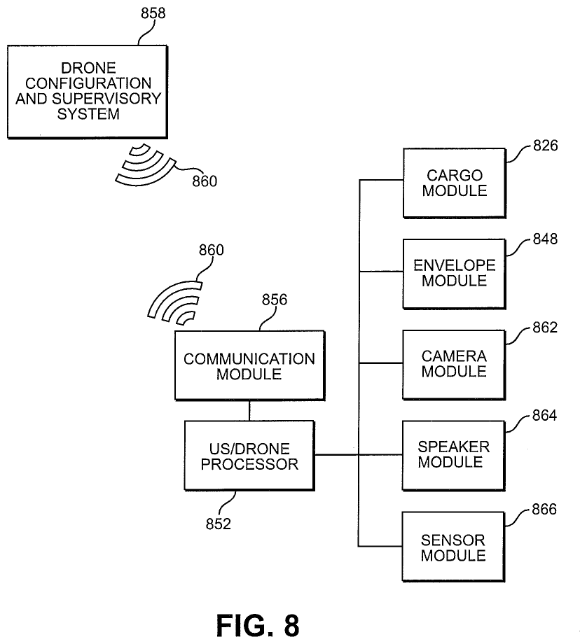

FIG. 8 is a block diagram of one embodiment of an unmanned system. The unmanned system may have one or more modules attached thereto. As a non-limiting example, the unmanned system may have a cargo module 826, an envelope module 848, a camera module 862, a speaker module 864, and a sensor module 866. The camera module 862 can have one or more cameras contained therein, where the cameras can be configured to capture high-resolution still images or motion video. The camera module 862 can send image data to a drone configuration and supervisory system 858 through the unmanned system/drone processor 852 and a communication module 856. The unmanned system/drone processor 854 can control camera features such as focal length, aperture, and orientation of the camera.

The communication module 856 can transmit and receive data by way of cellular data system such as 4G and 5G cellular systems, satellite communication systems, Wi-Fi, infrared, or any other form of wireless communication that will satisfy the communication needs of the unmanned system. The communication module 856 can communicate using two or more different communication methods simultaneously. As a non-limiting example, the communication module 856 can transmit and receive data specific to the operation of the unmanned system by cellular communication while simultaneously transmitting and receiving camera data via satellite communication. As another non-limiting example, the communication module 856 can transmit and receive data specific to the operation of the unmanned system by satellite while simultaneously transmitting and receiving camera data via Wi-Fi. The communication module 856 can also transmit data using one type of communication, such as cellular communication, while simultaneously receiving data using a different type of communication, such as satellite communication.

The speaker module 864 can broadcast sound, such as music, warnings, and instructions to persons near the unmanned system. Using the functions of the communication module 856, data representing a desired sound can be transmitted to the unmanned system where the unmanned system/drone processor 852 controls the speaker module 864 to broadcast the desired sound.

The sensor module 866 can be configured with one or more sensors capable of being carried by the unmanned system. For example, the sensor module 866 can contain a sensor configured to detect one or more particulate concentrations in the air, radiation, or biological contamination.

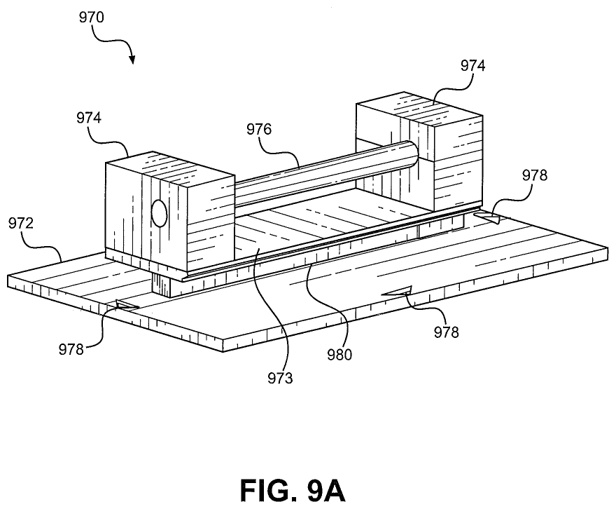

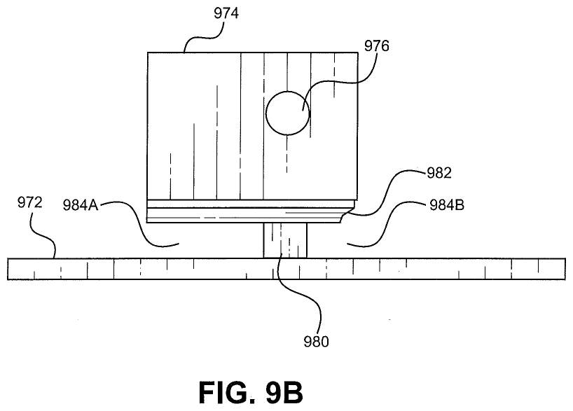

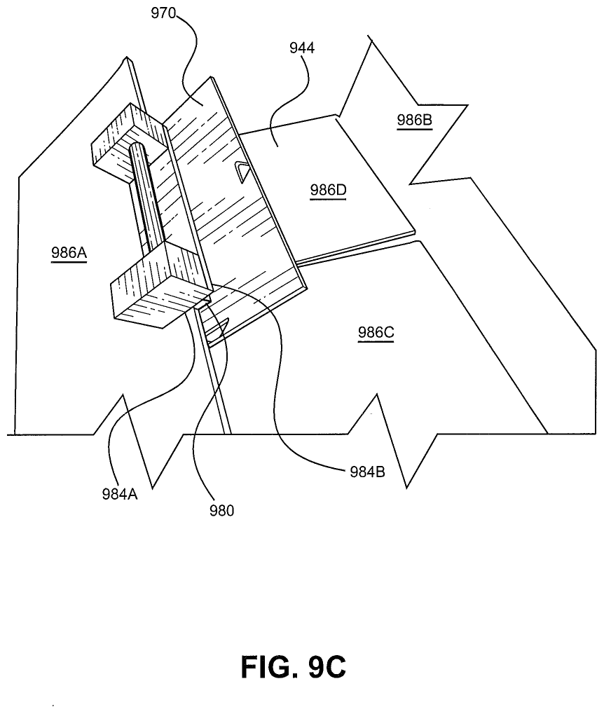

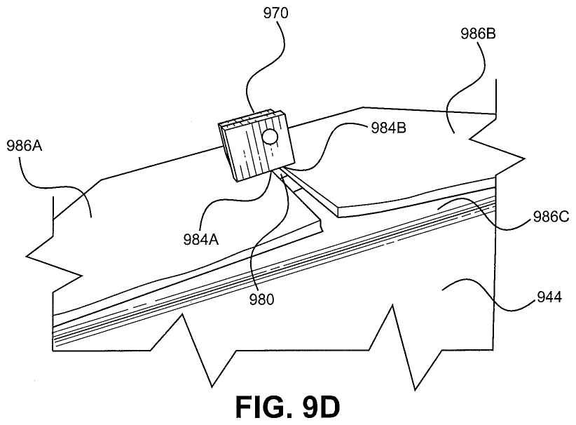

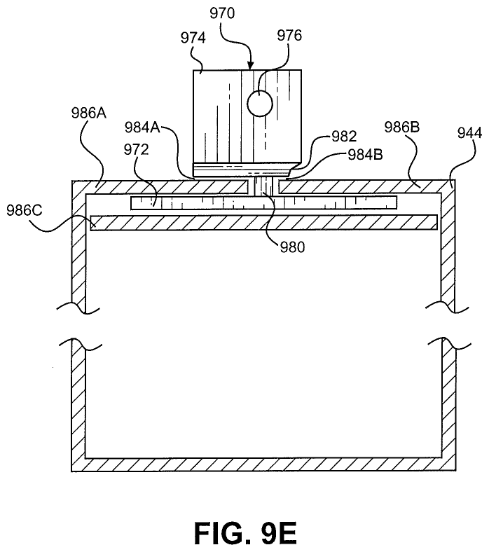

FIG. 9A is a perspective view of an embodiment of a bail hook and referred to as 970. Bail hook 970 comprises a base plate 972, a handle mount 974, a handle 976, position markers 978, and a spacer 980. The spacer 980 is located between the base plate 972 and handle plate 973. The handle mounts 974 are connected to the surface of the handle base 973 opposite the spacer 980. The handle 976 is connected between the handle mounts 974. In FIG. 9A, the handle 976 is depicted as a straight bar, however, the bar could be interchanged with a hook. The position markers 978 are located on the base plate 972 at the center of each edge of the base plate 972 and used to align the bail hook 970 approximately at the center of box flaps 986a and 986b, however, this positioning is not to be considered limiting.

Referring to FIG. 9B, a side view of the bail hook 970 is shown. As shown in FIG. 9B, the spacer 980 creates flap slots 984a and 984b. In a typical embodiment, the flap slots 984a and 984b are sized to receive box flaps 986a and 986a (see FIG. 9E). The flap slots 984a and 984b can be configured to receive any thickness of box flaps 986a and 986b. As a non-limiting example, flap slots 984a and 984b can be any thickness from 0.1 inches to 1.0 inches, including 0.1 inches, 0.2 inches, 0.3 inches, 0.4 inches, 0.5 inches, 0.6 inches, 0.7 inches, 0.8 inches, 0.9 inches, and 1.0 inches to accommodate different box cargo.

The spacer 980 and handle 976 are generally located in the center of the base plate 972 to allow for even loading when mounted to box cargo 944. However, the spacer 980 and handle 976 can be located anywhere on the base plate 972 in any orientation. As shown in FIG. 9B, the handle plate 973 and the handle mounts 974 are offset from the centerline of the base plate 972. In other embodiments, the handle plate 973 and the handle mounts 974 are symmetrically mounted to the base plate 972. The handle plate 973 has a bevel 982 configured on one edge.

Referring now to FIG. 9C, the bail hook 970 is shown partially engaged with a piece of box cargo 944. The box flap 986a is inserted into flap slot 984a after box flaps 986c and 986d have been folded down.

In FIG. 9D, the bail hook 970 is shown fully engaged with a piece of box cargo 944 where the box flap 986a is inserted into flap slot 984a and box flap 986b is inserted into flap slot 984b. Box flaps 986a and 986b can be secured in the closed position by using tape, adhesive, or any other means to secure the box flaps 986a and 986b in the closed position. After securing box flaps 986a and 986b in the closed position, bail hook 970 is secured in place and allows for the box cargo 944 to be lifted by the bail hook 970.

FIG. 9E is a cutaway view of a bail hook 970 fully engaged with a piece of box cargo 944. As shown, box flap 986c is folded down to a closed position. The base plate 972 is between box flap 986c and 986d (not shown). Box flap 986a is folded down and inserted into flap slot 984a. Box flap 986b is folded down and inserted into flap slot 984b. The handle plate 973 and handle mounts 974 are offset to avoid bending box flap 986b in unwanted locations while inserting into flap slot 984b. The bevel 982 allows the edge of box flap 986b to be easily inserted into flap slot 984b without damaging the box flap 986b.

In an alternative embodiment of the bail hook 970, the spacer 980, handle plate 973, the handle mounts 974, and the handle 976 are symmetrically mounted on base plate 972. In use, the box flaps 986a and 986b are fully closed onto top of box flaps 986c and 986d thereby forming gap 985. The bail hook 970 is then inserted between the box flaps 986a-d by aligning the spacer 980 with the gap 985 then sliding the bail hook 970 substantially to the center of the box cargo 944. Box flaps 986a and 986b are then secured by any means known in the industry capable of supporting the weight of the box cargo 944 during flight.

The bail hook 970 may be formed from individual pieces or may be formed as a single piece using, as a non-limiting example, injection molding. The bail hook 970 can be made from various materials, for example plastic, metal such as aluminum, or fiberglass. The bail hook 970 can also be made from a combination of materials. For example, the bail hook 970 can be made from injection molded plastic except for the handle 976, which can be made from metal or fiberglass thereby increasing the load carrying capacity of the bail hook 970.

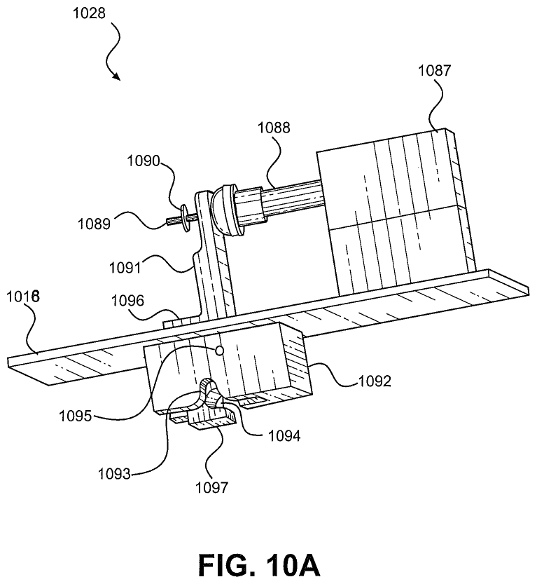

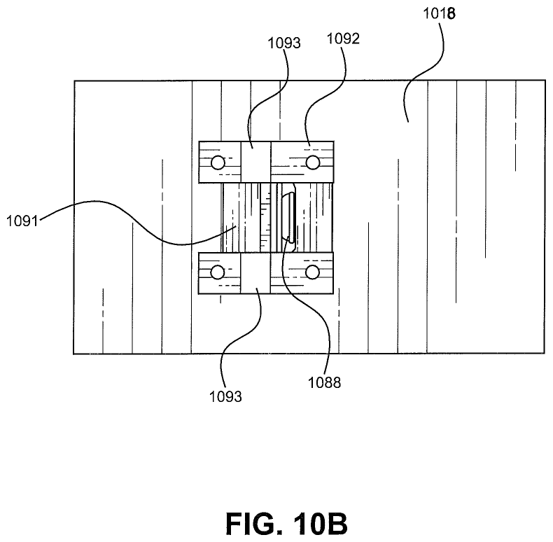

Referring now to FIG. 10A, a perspective view of a hold and release mechanism is shown and referred to as 1028. The hold and release mechanism 1028 comprises an actuator 1087, an activation rod 1088, an attachment pin 1089, an attachment disk 1090, a lever 1091 having a lever stop 1096, a lever slot 1094 and a lever hook 1097, a lever block 1092 having a handle slot 1093, and a pivot pin 1095. The hold and release mechanism 1028 is attached to a pallet plate 1018, however, the hold and release mechanism 1028 may be attached to any portion of a cargo module, for example cargo module 826, where the hold and release mechanism can mate with box cargo, for example box cargo 944 (see FIG. 9E) or envelope cargo 650 (see FIG. 6A).

The actuator 1087 is mounted to the pallet plate 1018 of the pallet 1016. The actuator may vary in shape and size to accommodate different weight loads. The activation rod 1088 is controlled by the actuator 1087 such that the activation rod 1088 extends out from and retracts into actuator 1087. The attachment pin 1089 attaches to an end of the lever 1091, typically through a hold in the lever 1091, thereby allowing the attachment pin 1089 to move freely relative to the lever 1091. The attachment disk 1090 is secured to the attachment pin 1089 at a distance from the activation rod 1088 thereby allowing the activation rod 1088 to start moving before the attachment disk 1090 contacts the lever 1091. Having the attachment disk 1090 secured to the attachment pin 1089 ensures the lever 1091 moves from an engaged position to a non-engaged position or from an engaged position to a non-engaged position while the hold and release mechanism 1028 is attaching to or detaching from a piece of cargo. The weight of any attached cargo may restrict the ability of the lever 1091 to move from an engaged position to a non-engaged position or from a non-engaged position to an engaged position, therefore, the positioning of the attachment disk 1090 allows the activation rod 1088 to start moving before the attachment disk 1090 contacts the lever 1091, thereby allowing the activation rod to gain momentum before contacting the lever 1091 while under load. Similarly, when the lever 1091 is to be attached to a piece of cargo, the activation rod 1088 can gain momentum before the activation rod 1088 contacts the lever 1091, thereby providing enough force to allow the lever slot 1094 to fully engage a piece of cargo.

The actuator 1087 can be located on the pallet plate 1018 such that the activation rod 1088 retracts to move the lever 1091 to the engaged position and extends to move the lever 1091 to the non-engaged position. The actuator 1087 can also utilize a cam that is rotated by the activation rod 1088, where the cam in turn moves the lever 1091 between the engaged position and the non-engaged position.

The lever block 1092 is located below and attached to the pallet plate 1018. The lever 1091 extends through the pallet plate 1018 and the lever block 1092. Pivot pin 1095 extends through the lever block 1092 and the lever 1091, thereby allowing the lever 1091 to rotate relative to the lever block 1092 from an engaged position to a non-engaged position. When in the engaged position, the lever slot 1094 engages a handle or attachment fixture, such as the handle 976 of the bail hook 970 (see FIG. 9A) or the retention loop 442 of attachment fixture 436 (see FIG. 4A). The handle slot 1093 is configured to receive a handle or loop where the lever slot 1094 works in conjunction with the handle slot 1093 to securely hold a handle or loop. The lever slot 1094 and handle slot 1093 can securely hold any object configured to be held by the hold and release mechanism 1028, for example, a loop of material, such as a D-ring, loop of cloth, or any material capable of being held by the lever slot 1094, which in turn is capable of being secured to a piece of cargo.

In some embodiments, the lever 1091 has a lever stop 1096. The lever stop 1096 is configured to prevent the lever 1091 from over rotating about pivot pin 976. The lever stop 1096 engages the pallet 1016 when the lever 1091 is moved to the engaged position thereby stopping the movement of the lever 1091. The lever stop 1096 can prevent the lever 1091 from applying excessive pressure to a handle or loop by the lever 1091 when the lever 1091 is moved into the engaged position, thereby preventing the lever 1091 from becoming stuck in the engaged position.

In an alternative embodiment, the bottom of the lever hook 1097 may be angled to allow for a handle to be inserted into handle slot 1093 and lever slot 1094 by applying an upward pressure on the lever hook 1097 with a handle or loop attached to the payload, which in turn moves the lever to a non-engaged position without the need to operate the actuator 1087. When the handle or loop is inserted into the handle slot 1093 and the lever slot 1094, the lever moves back to the engaged position thereby securely holding the handle or loop of the payload. In some embodiments, prior to flight, the actuator is activated or reactivated to ensure the lever is in the engaged position. In certain embodiments, the actuator 1087 can be energized or de-energized by a switch or button located on or near the respective module. In some embodiments, the actuator 1087 can be energized or de-energized by the unmanned system while autonomously picking up or dropping off a payload, such as cargo or other modules. In other embodiments, status indicators are located on or near a module to indicate to an operator the status of the actuator.

In certain embodiments, sensors are added to the hold and release mechanism 1028 to provide feedback to the unmanned system that indicate the position of the lever 1091 or the presence of a payload handle or loop in the handle slot 1093 or the lever slot 1094. The sensors may be optical where a beam is interrupted when the payload is present. In other embodiments, the sensors may indicate the presence of a payload when the handle or loop of the payload physically contacts the sensor. In additional embodiments, a combination of sensors are used to indicate the presence of a payload. A payload can be box cargo 544 (See FIG. 5), envelope cargo 650 (See FIG. 6), sensor modules 866 (See FIG. 8), or any other item configured to be secured by the hold and release mechanism 1028.

FIG. 10B is a bottom view of the hold and release mechanism 1028 with the lever 1091 in the engaged position. Also shown in FIG. 10B is the pallet plate 1018, the lever block 1092, the handle slot 1093, and the activation rod 1088, which is located on the side of the pallet plate 1018 or cargo pallet 721 (see FIG. 7A) opposite the lever block 1092.

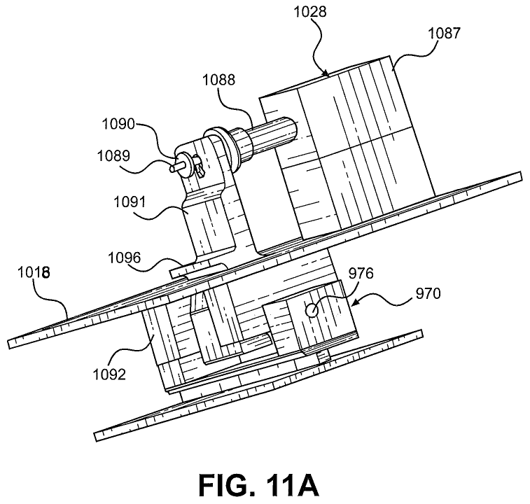

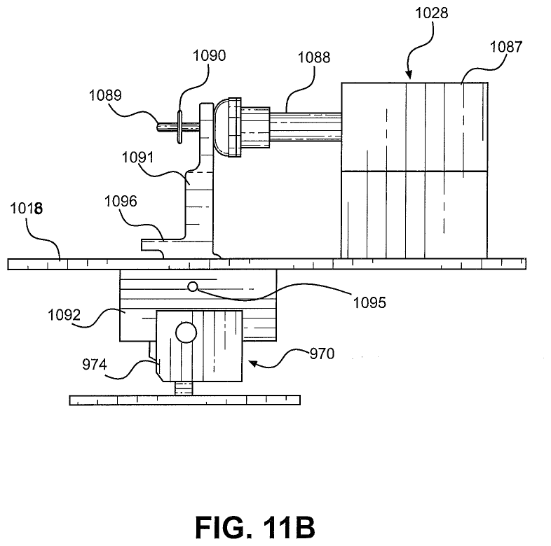

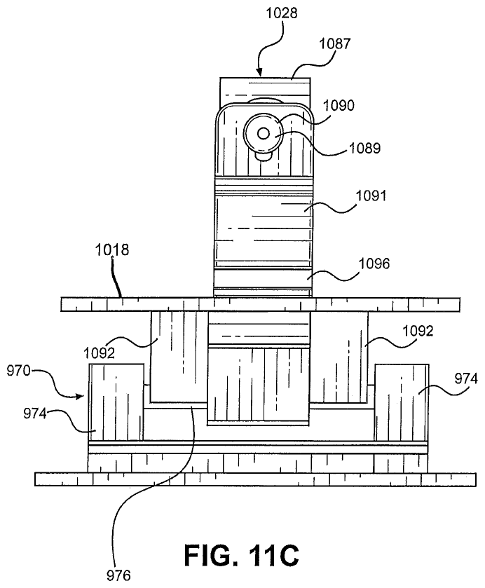

Referring now to FIG. 11A, the bail hook 970 is shown engaged with the hold and release mechanism 1028. As shown, the handle 976 of the bail hook 970 is inserted into the handle slot 1093. The actuator 1087 moves the activation rod 1088 thereby rotating the lever 1091 into the engaged position.

FIGS. 11B and 11C are a side view and a front view respectively of the hold and release mechanism 1028 engaged to a bail hook 970. As shown, the handle 976 of the bail hook 970 is engaged in the handle slot 1093 (not shown) and the lever slop 1094 (not shown) of the lever 1091.

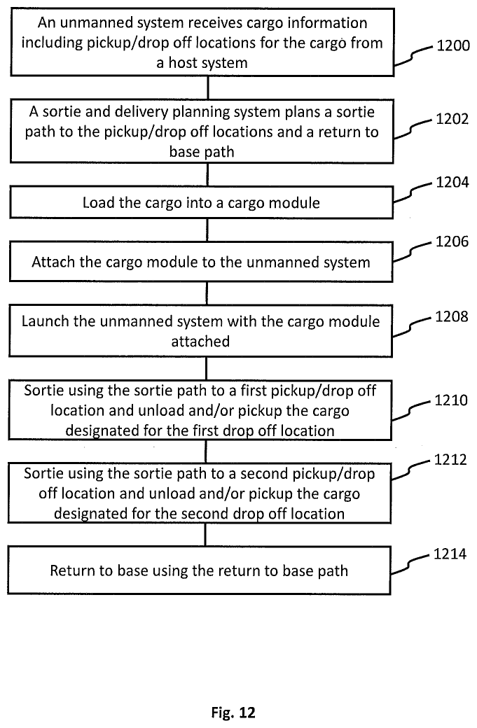

FIG. 12 is a flow chart showing a method of using the present invention. In step 1200, an unmanned system receives cargo information including pickup/drop off locations for the cargo from a host system. In step 1202, a sortie and delivery planning system plans a sortie path to the pickup/drop off locations and a return to base path. In step 1204, the cargo is loaded into a cargo module, where the cargo module is configured to attach to the unmanned system. In step 1206, the cargo module is attached to the unmanned system if the cargo module is not already attached to the unmanned system. The cargo module can be configured to carry, for example, box cargo, envelope cargo, a camera system, a speaker system, a sensor system, or any other cargo capable of being attached to and carried into the air by the unmanned system. In step 1208, the unmanned system is launched with the cargo module attached. In step 1210, the unmanned system sorties using the sortie path to a first pickup/drop off location and pickup and/or drop off the cargo designated for the first pickup/drop off location. In step 1212, the unmanned system sorties using the sortie path to a second pickup/drop off location and pickup and/or drop off the cargo designated for the second pickup/drop off location. In step 1214, the unmanned system returns to base using the return to base path.

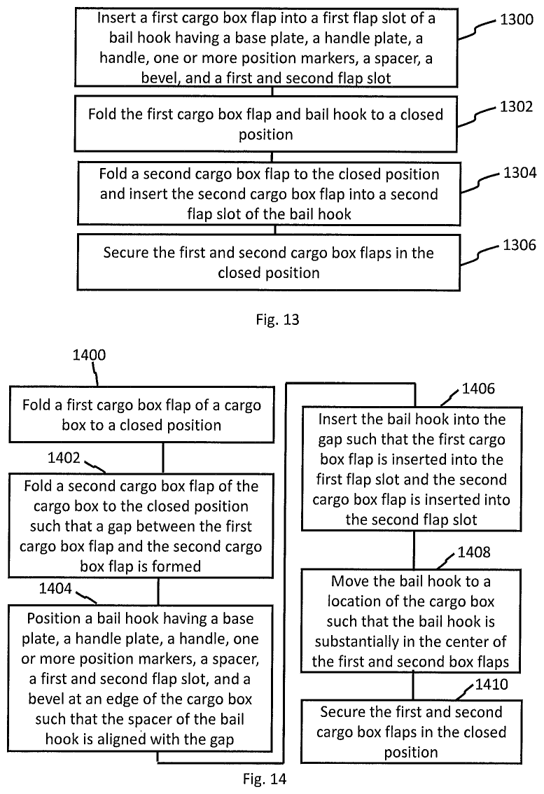

FIG. 13 is a flow chart showing a method of use of a bail hook having a base plate, a handle plate, a handle, one or more position markers, a spacer, a bevel, and a first and a second flap slot. In step 1300, a first cargo box flap of a piece of box cargo is inserted into the first flap slot. In step 1302, the first cargo box flap and the bail hook are folded to a closed position. In step 1304, a second cargo box flap is folded to a closed position and inserted into the second flap slot of the bail hook. In step 1306, the first and second box flaps are secured in the closed position thereby also securing the bail hook to the box cargo. The first and second box flaps can be secured in the closed position using any method known in the industry, including, but not limited to, adhesive tape, spray adhesive, or straps or wire made from, for example, cloth, plastic, or metal.

FIG. 14 is a flow chart showing an alternative method of use of a bail hook having a base plate, a handle plate, a handle, one or more position markers, a spacer, a bevel, and a first and second flap slot. In step 1400, a first cargo box flap of a piece of cargo is folded to the closed position. In step 1402, a second cargo box flap is folded to a closed position such that a gap is formed between the first cargo box flap and the second cargo box flap. In step 1404, the bail hook is positioned such that the spacer of the bail hook is aligned with the gap. In step 1406, the bail hook is inserted into the gap such that the first box flap is inserted into the first flap slot and the second box flap is inserted into the second flap slot. In step 1408, the bail hook is moved to a location of the first and second cargo box flaps such that the bail hook is substantially in the center of the first and second box flaps. In step 1410, the first and second box flaps are secured in the closed position thereby holding the bail hook in place during use. The first and second box flaps can be secured in the closed position using any method known in the industry, including, but not limited to, adhesive tape, spray adhesive, or straps or wire made from, for example, cloth, plastic, or metal.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

It is understood that although a number of different embodiments of the present invention have been illustrated and described herein, one or more features of any one embodiment can be combined with one or more features of one or more of the other embodiments, provided that such combination satisfies the intent of the present invention.

While a number of exemplary aspects and embodiments of the present invention have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. A bail hook comprising:
a base plate (972);
a spacer (980) mounted to the base plate (972); and
a handle (976) mounted to the spacer (980).

2. The bail hook of claim 1, further comprising:
a handle plate (973) located between the spacer (980) and the handle (976).

3. The bail hook of claim 1, further comprising at least one position marker (978).

4. The bail hook of claim 3, wherein the at least one position marker (978) is located along an edge of the base plate (972).

5. The bail hook of claim 4, wherein the at least one position marker (978) is located substantially at a center point of the edge of the base plate (972).

6. The bail hook of claim 3, further comprising a handle plate (973), wherein the at least one position marker (978) is located along an edge of the handle plate (972).

7. The bail hook of claim 6, where the at least one position marker (978) is located substantially at the center of the edge of the handle plate (972).

8. The bail hook of claim 1, further comprising a handle mount 974 located between the spacer (980) and the handle (976).

9. The bail hook of claim 1, further comprising a first flap slot (984a) and a second flap slot (984b), wherein the first flap slot (984a) is configured to receive a first box flap (986a) and the second flap slot (984) is configured to receive a second box flap (986b).

10. The bail hook of claim 1, further comprising a bevel (982).

11. The bail hook of claim 1, wherein the bail hook is made from plastic.

12. The bail hook of claim 1, wherein the bail hook is manufactured using injection molding.

13. The bail hook of claim 1, wherein the handle (976) is made from a material different from the base plate (972) and the spacer (980).

14. The bail hook of claim 1, wherein the handle (976) is made from metal.

15. A method of using a bail hook with a piece of cargo, the bail hook having a base plate (972), a spacer (980), a handle (976), a first flap slot (984a), and a second flap slot (984b), comprising the steps:
inserting a first box flap (986a) into the first flap slot (984a);
folding the first box flap (986a) and the bail hook to a closed position;
folding a second box flap (986b) to a closed position;
inserting the second box flap (986b) into the second flap slot (984b);
securing the first box flap (986a) and the second box flap (986b) in the closed position thereby securing the bail hook to the cargo.

16. The method of using a bail hook of claim 15, wherein the first box flap (986a) and the second box flap (986b) are secured in the closed position using at least one from the group consisting of tape, straps, adhesive, and wire.

17. The method of using a bail hook of claim 15, further including the step of positioning the bail hook substantially in the center of an edge of the first box flap (986a) and the second box flap (986b).

18. A method of using a bail hook, the bail hook having a base plate (972), a spacer (980), a handle (976), a first flap slot (984a), and a second flap slot (984b), comprising the steps:
folding a first cargo box flap (986a) of a piece of cargo (944) to a closed position;
folding a second cargo box flap (986b) of a piece of cargo (944) to a closed position thereby forming a gap (985) between the first cargo box flap (986a) and the second cargo box flap (986b);
positioning the bail hook at an edge of the piece of cargo (944) such that the spacer (980) is aligned lengthwise with the gap (985);
inserting the bail hook into the box gap (985) such that the first cargo box flap (986a) is inserted into the first flap slot (984a) and the second cargo box flap (986b) is inserted into the second flap slot (984b); and
securing the first cargo box flap (986a) and the second cargo box flap (986b) in the closed position.

19. The method of using a bail hook of claim 18, further comprising the step of moving the bail hook to a position substantially in the center of the first box flap (986a) and the second box flap (986b).

20. The method of using a bail hook of claim 18, wherein the first box flap (986a) and the second box flap (986b) are secured in the closed position using at least one from the group consisting of tape, straps, adhesive, and wire.
